(19) United States
(12) Patent Application Publication
(10) Pub. No.: US 2025/0042397 A1
(43) Pub. Date: Feb. 6, 2025

(54) DRIVER ASSISTANCE DEVICE

(71) Applicant: TOYOTA JIDOSHA KABUSHIKI KAISHA, Toyota-shi (JP)

(72) Inventor: Yuki TEZUKA, Toyota-shi (JP)

(73) Assignee: TOYOTA JIDOSHA KABUSHIKI KAISHA, Toyota-shi (JP)

(21) Appl. No.: 18/591,231

(22) Filed: Feb. 29, 2024

(30) Foreign Application Priority Data
Aug. 4, 2023 (JP) 2023-128080

(51) Int. Cl. B60W 30/16; B60W 30/09; B60W 30/095; B60W 60/00

(52) U.S. Cl. CPC B60W 30/16; B60W 30/09; B60W 30/0956; B60W 60/001; B60W 2420/403; B60W 2420/408; B60W 2554/4045; B60W 2554/80

(57) ABSTRACT

A driver assistance device includes an in-vehicle sensor configured to acquire target information about a target that is present around a host vehicle, and a processor configured to perform a driver assistance process of determining a driver assistance level, which is a degree of assistance in a driving maneuver, based on the target information, and controlling the host vehicle so that assistance of the driver assistance level is provided to the driver. During the driver assistance process of a predetermined first level, when a first condition is satisfied, the processor starts execution of the driver assistance processing of a second level lower than the first level in place of the driver assistance processing of the first level, and maintains the driver assistance level at the second level in a period in which a second condition is satisfied.

### CROSS-REFERENCE TO RELATED APPLICATION

This application claims priority to Japanese Patent Application No. 2023-128080 filed on Aug. 4, 2023, incorporated herein by reference in its entirety.

### BACKGROUND

### 1. Technical Field

The present disclosure relates to driver assistance devices that assist in driving maneuvers of a host vehicle.

### 2. Description of Related Art

A driver assistance device that assists in driving maneuvers of a host vehicle has been proposed (see, for example, Japanese Unexamined Patent Application Publication No. 2015-153153 (JP 2015-153153 A) below). This driver assistance device (hereinafter referred to as “conventional device”) has an autonomous driving function to control the host vehicle to travel automatically. When an other vehicle is highly likely to enter (cut in) between the host vehicle and the preceding vehicle (vehicle immediately in front of the host vehicle) during autonomous driving control, this conventional device controls a braking device (and/or a drive device) of the host vehicle so that the distance between the host vehicle and the preceding vehicle increases. This allows the other vehicle to easily enter between the host vehicle and the preceding vehicle.

### SUMMARY

A driver assistance device has been proposed that has, for example, a hands-on mode and a hands-off mode as operation modes for autonomous driving control. In either operation mode, the steering angle is automatically adjusted. In the hands-on mode, a driver needs to lightly touch the steering wheel. In the hands-off mode, on the other hand, a driver is allowed to release his or her hands from the steering wheel (hands off). However, when a predetermined condition (cancellation condition) is satisfied in the hands-off mode, the operation mode is forcibly changed from the hands-off mode to the hands-on mode. For example, the cancellation condition is satisfied when the distance between the host vehicle and an other vehicle that has entered between the host vehicle and the preceding vehicle becomes less than a threshold in the hands-off mode. The driver assistance device thus lowers the driver assistance level when the predetermined condition is satisfied.

In a scene where the cancellation condition is satisfied, there is a high possibility that the same cancellation condition is repeatedly satisfied within a short period of time thereafter. In the case where the driver assistance device is configured so that the driver assistance level is restored as soon as the cancellation condition becomes unsatisfied, the driver assistance level may be frequently changed. The driver may therefore feel annoyed by the frequent changes (chattering) in the driver assistance level.

It is an object of the present disclosure to provide a driver assistance device that can reduce frequent changes in the driver assistance level.

In order to solve the above problem, a driver assistance device (1) according to an aspect of the present disclosure assists in a driving maneuver of a host vehicle (V). The driver assistance device includes: an in-vehicle sensor (20) configured to acquire target information about a target that is present around the host vehicle (V); and
a processor (10) configured to perform a driver assistance process of determining a driver assistance level based on the target information and controlling the host vehicle in such a manner that assistance of the driver assistance level is provided to a driver, the driver assistance level being a degree of assistance in the driving maneuver.

The processor is configured to, when a first condition (Xn1) is satisfied during the driver assistance process of a predetermined first level, start performing the driver assistance process of a second level instead of the driver assistance process of the first level. The first condition (Xn1) is a condition defined in advance as a condition for lowering the driver assistance level, and the second level is lower than the first level.

The processor is configured to maintain the driver assistance level at the second level during a period in which a second condition (Xn2) is satisfied. The second condition (Xn2) is a condition defined in advance as a condition for determining that a situation is that the first condition is highly likely to be satisfied.

According to the driver assistance device of the above aspect of the present disclosure, after the driver assistance level is lowered from the first level to the second level, driver assistance of the second level continues to be provided to the driver in a situation where the first condition is highly likely to be satisfied. Therefore, frequent changes in the driver assistance level are reduced compared to the above conventional device.

In the driver assistance device according to the above aspect of the present disclosure,
the processor may be configured to, when determination is made that an other vehicle traveling in a second travel lane adjacent to a first travel lane in which the host vehicle is traveling is highly likely to enter the first travel lane, perform a following distance adjustment process of controlling either or both of a drive device of the host vehicle and a braking device of the host vehicle so as to allow the other vehicle to enter an area immediately in front of the host vehicle, and
the processor may be configured to determine that the first condition is satisfied when a distance (Δd1) between the host vehicle and the other vehicle or a predicted time (TTC1) until contact between the host vehicle and the other vehicle becomes less than a threshold in a situation where the processor is performing the following distance adjustment process.

According to this configuration, the driver assistance level is lowered when an other vehicle is highly likely to enter the area immediately in front of the host vehicle and the host vehicle and the other vehicle are highly likely to come into contact with each other. Accordingly, in the event of an emergency (e.g., when the host vehicle and the other vehicle have approached each other quickly), the driver can smoothly start a maneuver to avoid any risk that may be caused by this emergency.

In the driver assistance device according to the above aspect of the present disclosure,
the processor may be configured to determine that the second condition is satisfied when the host vehicle is traveling in a merging section of a travel lane.

There is a possibility that a plurality of other vehicles may sequentially enter the area immediately in front of the host vehicle in the merging section. The first condition is therefore highly likely to be relatively frequently satisfied in the merging section. According to the present disclosure, the driver assistance level is maintained at the second level while the vehicle is traveling in this section. In other words, frequent changes in the driver assistance level are reduced.

In the driver assistance device according to the above aspect of the present disclosure,
the processor may be configured to determine that the second condition is satisfied in a situation that a still other vehicle different from the other vehicle is highly likely to enter the area.

It is assumed that a still other vehicle (a second other vehicle) is trying to enter the area immediately in front of the host vehicle after the driver assistance level is lowered in response to approach of an other vehicle (a first other vehicle) trying to enter this area to the host vehicle. When such a scene occurs, the first condition is highly likely to be satisfied later on for the second other vehicle even if the first condition is not satisfied at the moment for the second other vehicle. According to the driver assistance device of this aspect, the driver assistance level is maintained at the second level in this scene. In other words, frequent changes in the driver assistance level are reduced.

In the driver assistance device according to the above aspect of the present disclosure, the processor may be configured to measure an elapsed time (Δt) since a first time point at which determination was made that the first condition was satisfied, and
when the other vehicle becomes no longer detectable after the first time point, determine that the second condition is satisfied in a situation where the elapsed time is less than a threshold (Δtth).

For example, it may be difficult for the in-vehicle sensor to accurately perceive other vehicles at night or in rainy weather. In this case, the driver assistance level is maintained at the second level in a situation where the elapsed time is less than the threshold (e.g., an average time it typically takes for a vehicle to change lanes). In other words, frequent changes in the driver assistance level are reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a driver assistance device according to an embodiment of the present disclosure;

FIG. 2 is a plan view of a merging section of an expressway and its periphery;

FIG. 3 is a plan view showing a section other than a merging section of an expressway;

FIG. 4 is a flowchart of a program for setting flag FH;

FIG. 5A is a flowchart of a program for setting a flag FXn;

FIG. 5B is a flowchart of a program for setting a flag FXn;

FIG. 6A is a flowchart of a program for determining whether a specific condition is satisfied; and

FIG. 6B is a flowchart of a program for determining whether a specific condition is satisfied.

### DETAILED DESCRIPTION OF EMBODIMENTS

### Overview

The driver assistance device 1 according to an embodiment of the present disclosure is mounted on a vehicle V (hereinafter, referred to as an “host vehicle”). The driver assistance device 1 assists in driving maneuvers that are performed by a driver. For example, the driver assistance device 1 has a function (autonomous driving function) to perform autonomous driving control for controlling the host vehicle so that the host vehicle travels automatically. The driver assistance device 1 changes the degree of assistance in driving maneuvers (driver assistance level) depending on the situation.

### Specific Configuration

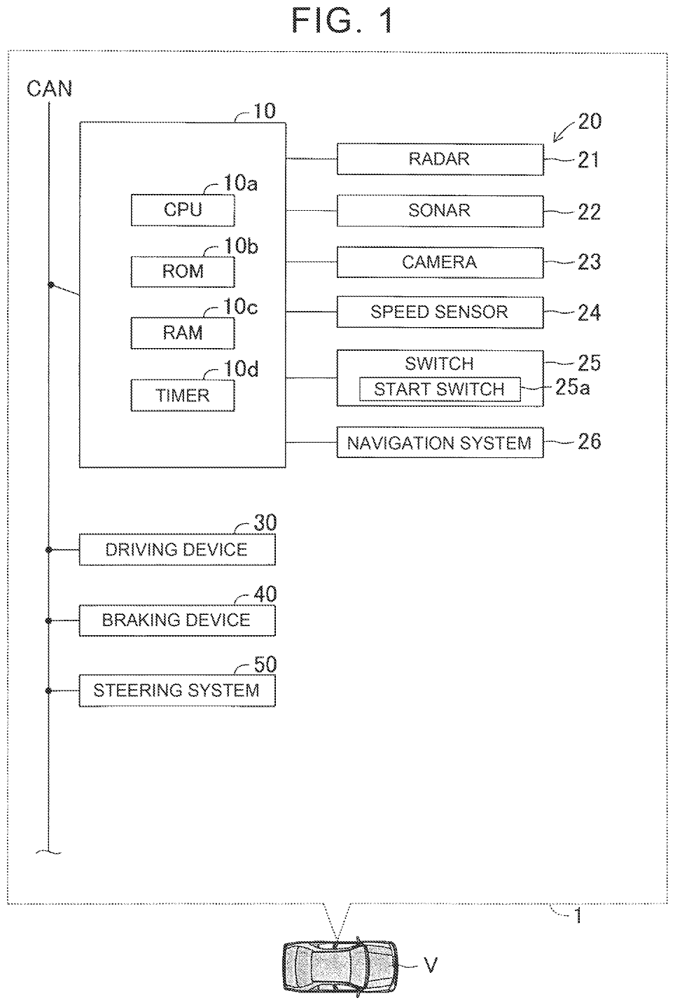

As illustrated in FIG. 1, the driver assistance device 1 includes a driver assistance ECU 10, an in-vehicle sensor 20, a driving device 30, a braking device 40, and a steering system 50.

The driver assistance ECU 10 includes a CPU 10a, ROM 10b, RAM 10c, a timer 10d, and the like. The driver assistance ECU 10 is connected to another ECU via a CAN. Other ECU are, for example, ECU of the driving device 30, the braking device 40, and the steering system 50 which will be described later.

The in-vehicle sensor 20 includes a radar 21, a sonar 22, and a camera 23 as ambient sensors that acquire information (target information) about a target object that is present around the host vehicle.

The radar 21 includes a transmission/reception unit and a signal processing unit. The transmission and reception unit radiates a millimeter-wave band radio wave (hereinafter, referred to as “millimeter wave”) toward the front of the host vehicle, and receives a millimeter wave (reflected wave) reflected by a three-dimensional object located within a radiation range. The signal processing unit perceives the distance between the host vehicle and the three-dimensional object, the relative position (direction) of the three-dimensional object with respect to the host vehicle, and the like on the basis of the time from the emission of the millimeter wave to the reception of the reflected wave by the transmitting/receiving unit, the phase difference between the transmitted millimeter wave and the received reflected wave, the attenuation degree of the reflected wave, and the like. The driver assistance ECU 10 is configured to send the perception results.

The sonar 22 intermittently radiates an ultrasonic wave to a surrounding area of the host vehicle, and receives an ultrasonic wave (reflected wave) reflected by a three-dimensional object. The sonar 22 perceives the distance between the host vehicle and the three-dimensional object, the relative position (direction) of the three-dimensional object with respect to the host vehicle, and the like based on the time from the transmission of the ultrasonic wave to the reception of the reflected wave. The sonar 22 transmits the perception results to the driver assistance ECU 10.

The camera 23 includes an imaging device and an image analysis device. The imaging device incorporates, for example, a CCD. The imaging device is installed at a front portion of the host vehicle. The imaging device captures a foreground of the host vehicle at a predetermined frame rate, and acquires image data. The image analysis device analyzes the image data and perceives from the image a target and indication that are present around the host vehicle. For example, the image analysis device perceives other vehicles, lane marks (dividing lines, curbstones, separating bands, and the like that define the travel lanes), and the like, and transmits the perception results to the driver assistance ECU 10. Note that the image analysis device can identify a plurality of other vehicles based on the shape, color, number described on the license plate, and the like of the other vehicles.

In addition, the in-vehicle sensor 20 includes a vehicle speed sensor 24 that detects the vehicle speed of the host vehicle. Further, the in-vehicle sensor 20 includes a switch 25. The switch 25 includes a push-button type start switch 25a for requesting the driver to start an automated driving process to be described later with respect to the driver assistance device 1. Each time the start switch 25a is depressed, the on/off status of the switch 25a alternates.

Further, the in-vehicle sensor 20 includes a navigation system 26. In addition, the in-vehicle sensor 20 includes a sensor (not shown) that detects the depression depth of the brake pedal, a sensor (not shown) that detects whether the driver is touching the steering wheel, and the like.

The driving device 30 applies a driving force to the driving wheels. The driving device 30 includes an engine ECU, an internal combustion engine, a transmission, a drive force transmission mechanism that transmits the drive force to the wheels, and the like. The engine ECU controls the throttle valve such that the power of the internal combustion engine matches the target. In addition, the engine ECU controls the transmission so that the shift position of the transmission included in the host vehicle matches the target position.

When the vehicle to which the driver assistance device 1 is applied is hybrid electric vehicle (HEV), the engine ECU can control the driving force of the vehicle generated by either or both of the “internal combustion engine and the electric motor” as the vehicle driving source. When the vehicle to which the driver assistance device 1 is applied is an electric vehicle (BEV), an electric motor ECU that controls the driving force of the vehicle generated by an “electric motor” as a vehicle driving source is used instead of the engine ECU.

The braking device 40 applies a braking force to the wheels (brake discs). The braking device 40 includes a brake ECU, a brake caliper, and the like. The brake ECU controls the brake caliper so that the braking force applied to the wheels matches the target value.

The steering system 50 controls the steering angles of steered wheels (left front wheel and right front wheel). The steering system 50 includes a steering ECU, a steering mechanism, and the like. The steering system 50 further includes an actuator that drives the steering mechanism to change the steering angle. The steering ECU controls the actuator so that the steering angle matches the target.

### Automatic Operation Function

When the driver assistance ECU 10 detects that the start switch 25a has transitioned to the on-state, it starts the autonomous driving process (driver assistance process). That is, the driver assistance ECU 10 controls the driving device 30, the braking device 40, and the steering system 50 (hereinafter, referred to as “driving device and the like”) so that the host vehicle automatically travels along the travel lane (or a preset route) that is currently traveling. The driver assistance device 1 has a hands-off mode and a hands-on mode similar to those of the conventional device as the operation mode MD of the autonomous driving function. In the hands-on mode, when the driver detects that the driver is not touching the steering wheel, the driver assistance ECU 10 controls the notification device so that a predetermined alarm is issued.

The driver assistance ECU 10 uses the flag FXn (n=1, 2, . . . , max) and the flag FH to switch the operation mode MD in the autonomous driving process.

The flag FXn is associated with a corresponding condition Xn1 for determining that it is preferable to set the operation mode MD to the hands-on mode. The driver assistance ECU 10 sets the flag FXn to “1” when the condition Xn1 is satisfied. On the other hand, when the condition Xn1 is unsatisfied, the driver assistance ECU 10 sets the flag FXn to “0”. However, the driver assistance ECU 10 sets the flag FXn (n=a, b, c, . . . ) to “1” by setting the specific condition Xn1 (n=a, b, c, . . . ) to be satisfied as a trigger, and then, even if the specific condition Xn1 becomes unsatisfied, the driver assistance ECU 10 maintains the flag FXn at “1” during a period in which the condition Xn2 for determining that the specific condition Xn1 is highly likely to be satisfied is satisfied. Thereafter, when the condition Xn1 is unsatisfied and the condition Xn2 is unsatisfied, the driver assistance ECU 10 sets the flag FXn to “0”. As described above, the condition for changing the particular flag FXn (n=a, b, c, . . . ) from “1” to “O” is stricter than the condition for changing from “0” to “1”.

The flag FH indicates whether or not hands-off is allowed. When the flag FH is “0”, hands-off is prohibited, and when the flag FH is “1”, hands-off is allowed. When the at least one flag FXn is “1” (when the logical sum of all the flag FXn is “1”), the driver assistance ECU 10 sets the flag FH to “O”. That is, the driver assistance ECU 10 prohibits the hands-off. That is, the driver assistance ECU 10 sets the operation mode MD to the hands-on mode. On the other hand, when all the flag FXn are “0” (when the logical sum of all the flag FXn is “0”), the driver assistance ECU 10 sets the flag FH to “1”. That is, the driver assistance ECU 10 allows hands-off. That is, the driver assistance ECU 10 sets the operation mode MD to the hands-off mode.

For example, when the host vehicle is traveling on a normal road or traveling on an expressway at a relatively high speed (for example, at least 40 km/h), the driver assistance ECU 10 determines that the condition X11 is satisfied, and sets the flag FX1 to “1”. On the other hand, when the host vehicle is traveling on the expressway at a relatively low speed (less than 40 km/h), the driver assistance ECU 10 determines that the condition X11 is unsatisfied, and sets the flag FX1 to “0”. Note that the service area (rest spot) provided on the expressway is included in the general road in the present embodiment.

Further, for example, when the distance Δd0 between the host vehicle and the preceding vehicle (vehicle V2) is less than the threshold Δd0th (or when the predicted time TTC0 until collision of the host vehicle with the vehicle V2 is less than the threshold TTC0th), the driver assistance ECU 10 determines that the condition X21 is satisfied and sets the flag FX2 to “1”. On the other hand, when the distance Δd0 is equal to or greater than the threshold Δd0th (or when the predicted time TTC0 is equal to or greater than the threshold ΔTTC0th), the driver assistance ECU 10 determines that the condition X21 is unsatisfied, and sets the flag FX2 to “0”. In the present embodiment, the “preceding vehicle” (vehicle V2) means a vehicle traveling immediately before the host vehicle among vehicles traveling in the same travel lane as the travel lane L0 in which the host vehicle is traveling. A vehicle that straddles a division line that partitions the travel lane L0 and the travel lane L1 adjacent thereto is not included in the “preceding vehicle”.

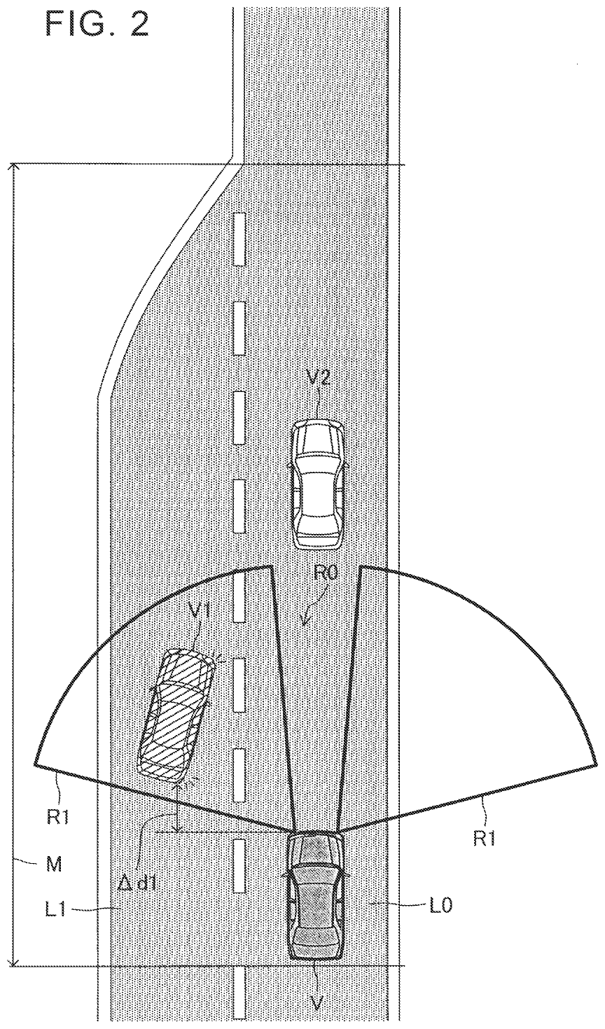

In addition, when the risk of contact between the host vehicle and another vehicle (vehicle V1) traveling in the travel lane L1 is high, the driver assistance ECU 10 determines that the condition X31 is satisfied, and sets the flag FX3 to “1”. Specifically, the driver assistance ECU 10 monitors the behavior of the vehicle V1 traveling on the travel lane L1 adjoining the travel lane L0 on which the host vehicle is traveling. For example, as shown in FIG. 2, when a vehicle V1 located in a predetermined area in the travel lane L1 and located in an area R1 obliquely ahead of the host vehicle is blinking a turn signal on the travel lane L0, the driver assistance ECU 10 determines that the vehicle V1 is highly likely to enter the area R0 immediately before the host vehicle. The area R0 is a rectangular area extending forward from the front end of the host vehicle. The width of the area R0 is the same as the width of the travel lane L0. The length of the area R0 is the same as the distance between the rear end of the vehicle V2 and the front end of the host vehicle. When the vehicle V2 does not exist, the length of the area R0 is about twice the total length of the host vehicle. Further, when the vehicle V1 straddles the dividing line that partitions the travel lane L0 and the travel lane L1 in front of the host vehicle, the driver assistance ECU 10 determines that the vehicle V1 is highly likely to enter the area R0. When it is determined that the vehicle V1 is highly likely to enter the area R0, the driver assistance ECU 10 performs a following distance adjustment process of controlling the driving device 30 and/or the braking device 40 of the host vehicle such that the distance Δd1 (distance in the front-rear direction) between the host vehicle and the vehicle V1 is equal to or greater than the threshold Δd1th (>Δd0th) (or the predicted time TTC1 is equal to or greater than the threshold TTC1th (>TTC0th)). The driver assistance ECU 10 prompts the vehicle V1 to enter the area R0 by performing the following distance adjustment process. However, for example, when the vehicle V1 suddenly decelerates, the distance Δd1 may temporarily become less than the threshold Δd1th. Then, the driver assistance ECU 10 determines that the risk of contact between the vehicle V1 and the host vehicle is high. In this case, the driver assistance ECU 10 determines that the condition X31 (the first condition of the present disclosure) is satisfied, and sets the flag FX3 to “1”. That is, hands-off is prohibited. Thus, for example, when the vehicle V1 further decelerates and approaches the host vehicle further, the driver immediately operates the steering wheel (steering override), thereby avoiding contact between the host vehicle and the vehicle V1.

The driver assistance ECU 10 continuously monitors the behavior of the vehicle V1 after setting the flag FX3 to “1”. Here, even if the condition X31 becomes temporarily unsatisfied after the condition X31 is satisfied, the condition X31 may become satisfied again immediately after that.

Before the entry of the vehicle V1 into the area R0 is completed, for example, after the condition X31 is satisfied, even if the condition X31 becomes unsatisfied by temporarily increasing the distance Δd1 and becoming equal to or larger than the threshold Δd1th after the increase in the distance Δd1, there is a possibility that the distance Δd1 may decrease to a value less than the threshold Δd1th afterwards and the condition X31 may be satisfied.

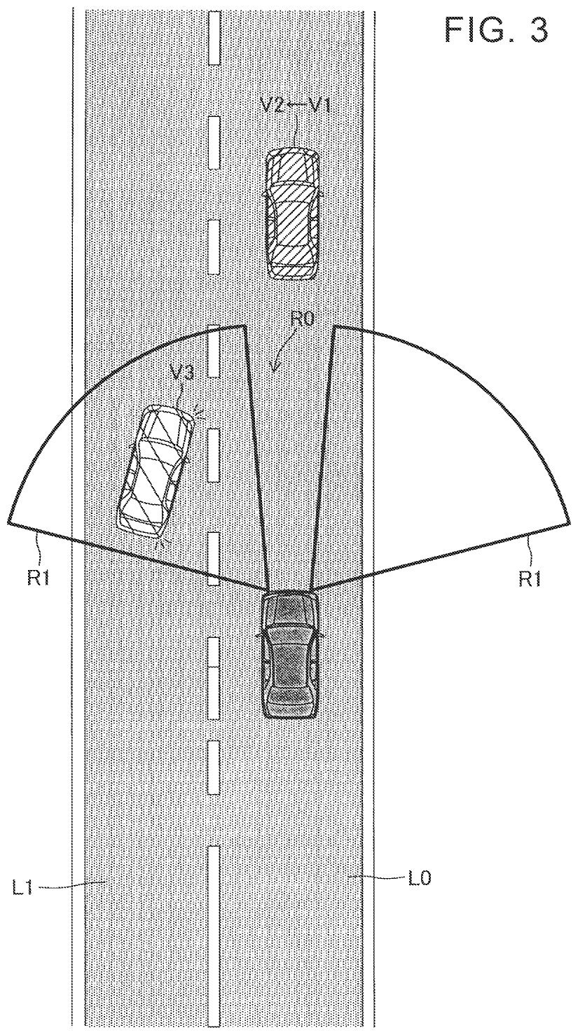

Further, when the host vehicle is traveling in the merging section M of the travel lane L1 and the travel lane L0, there is a possibility that another vehicle V3 may follow the vehicle V1 and enter the area R0 from the area R1. Further, as shown in FIG. 3, while traveling in a section other than the merging section of the expressway, there is a possibility that the vehicle V3 may follow the vehicle V1 and enter the area R0. The vehicle V1 is a vehicle in which the lane change is completed, and is the vehicle V2 in FIG. 3. In these cases, even if the condition X31 is unsatisfied for the vehicle V1, the condition X31 is highly likely to be satisfied for the vehicle V3.

Therefore, as described below, the driver assistance ECU 10 maintains the flag FX3 at “1” during the time when the condition X32 for determining that the condition X31 is highly likely to be satisfied is satisfied.

Specifically, the driver assistance ECU 10 determines that the condition X32 is satisfied while the vehicle V1 enters the area R0. In addition, in a situation where the host vehicle is traveling in the merging section M, the driver assistance ECU 10 determines that the condition X32 is satisfied. In addition, when there is a vehicle V3 in which the host vehicle is traveling in a section (non-merging section) that is not the merging section M and the direction-indicating light on the travel lane L0 is blinking in the area R1, the driver assistance ECU 10 determines that the condition X32 is satisfied regardless of the distance Δd1.

On the other hand, the driver assistance ECU 10 perceives that the entry of the vehicle V1 into the area R0 has been completed, and determines that the condition X32 is unsatisfied when the host vehicle is not traveling in the merging section M and there is no vehicle V3 to enter the area R0.

It should be noted that the driver assistance ECU 10 may be difficult to perceive that the entry of the vehicle V1 into the area R0 has been completed in a situation where the image recognition accuracy by the camera 23 is reduced (rainy weather, night time, etc.). As described above, when the vehicle V1 can no longer be perceived (has been lost sight of) after the time point t0 at which the flag FX3 is set to “1”, the driver assistance ECU 10 considers that the entry of the vehicle V1 into the area R0 is completed at the time point t1 at which the elapsed time Δt since the time point to reaches the threshold Δtth.

When the brake pedal is depressed, the driver assistance ECU 10 determines that the condition X41 is satisfied, and sets the flag FX4 to “1”. On the other hand, when the brake pedal is released, the driver assistance ECU 10 determines that the condition X41 is unsatisfied, and sets the flag FX3 to “0”. However, when the brake pedal is depressed during the following distance adjustment process, the driver assistance ECU 10 determines that the condition X31 is satisfied in addition to the condition X41. That is, the driver assistance ECU 10 sets the flag FX4 to “1” and sets the flag FX3 to “1” regardless of the distance Δd1 (even if the distance Δd1 is equal to or greater than the threshold Δd1th).

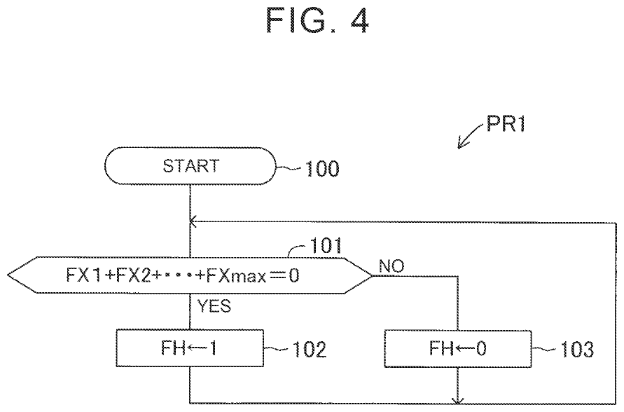

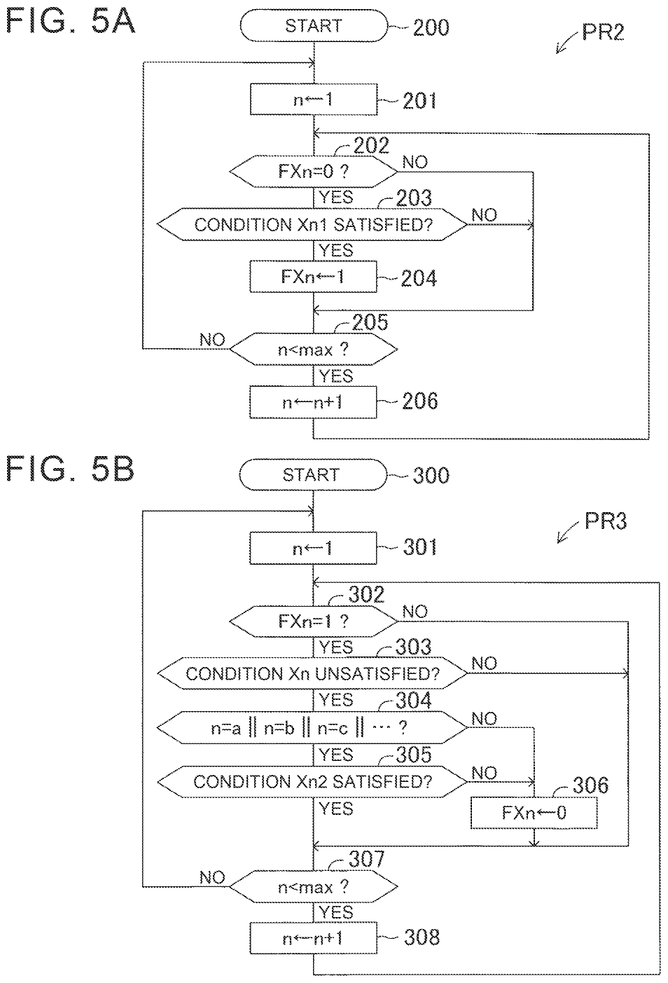

Next, referring to FIG. 4, FIG. 5A, and FIG. 5B, a program PR1, a program PR2, and a program PR3 executed by the CPU 10a (hereinafter, simply referred to as “CPU”) in order to realize a function of switching the operation mode MD according to circumstances will be described. When the CPU detects that the start switch 25a has transitioned to the on-state, it starts executing the program PR1 to the program PR3. When the CPU detects that the switch 25a is in the off-state, it suspends the program PR1 or the program PR3.

### Program PR1

The CPU starts executing a program PR1 (FIG. 4) from step 100, and advances the process to step 101.

In step 101, the CPU calculates a logical sum of the flags FX1 to FXmax, and determines whether or not the logical sum is “0”. The CPU executes the program PR1 and executes the program PR2 and the program PR3 (parallel processing) to be described later, thereby setting the flag FX1 to the flag FXmax to “1” or “0”, respectively. When the CPU determines that the logical sum is “0” (101: Yes), the process proceeds to step 102. On the other hand, when the CPU determines that the logical sum is not “0” (101: No), the process proceeds to step 103.

In step 102, the CPU sets the flag FH to “1” (permits hands-off), and returns the process to step 101. On the other hand, in step 103, the CPU sets the flag FH to “0” (prohibits the hands-off), and returns the process to step 101.

### Program PR2

A program PR2 includes a process (steps) of sequentially selecting a flag FXn (n=1, 2, 3, . . . , max) as a processing target and changing the flag FXn from “0” to “1” when the condition Xn1 is satisfied. Note that the process of changing the flag FXn from “1” to “0” is not included in the program PR2, but is included in a program PR3 to be described later.

The CPU starts executing the program PR2 (FIG. 5A) from step 200, and advances the process to step 201.

In step 201, the CPU sets the index n for specifying (selecting) the flag FXn to be processed to “1”. The CPU then proceeds to step 202.

In step 202, the CPU determines whether or not the flag FXn is “0”. When the CPU determines that the flag FXn is “0” (202: Yes), the process proceeds to step 203. On the other hand, when the CPU determines that the flag FXn is not “0” (202: No), the process proceeds to step 205, which will be described later.

In step 203, the CPU determines whether the condition Xn1 is satisfied. When the CPU determines that the condition Xn1 is satisfied (203: Yes), the process proceeds to step 204. On the other hand, when the CPU determines that the condition Xn1 is not satisfied (203: No), the CPU proceeds to step 205.

The CPU sets the flag FXn to “1” in step 204. The CPU then proceeds to step 205.

In step 205, the CPU determines whether the index n is less than the maximal max. When the CPU determines that the index n is less than the maximum-value max (205: Yes), the process proceeds to step 206. On the other hand, when the CPU determines that the index n is not less than the maximal value max (205: No), the process returns to step 201.

The CPU increments the index n at step 206. The CPU then returns to step 202.

### Program PR3

A program PR3 includes a process (steps) of sequentially selecting a flag FXn (n=1, 2, 3, . . . , max) as a processing target, and changing the flag FXn from “1” to “O” when the condition Xn1 (the condition Xn1 and the condition Xn2 in a particular flag FXn) is unsatisfied.

The CPU starts executing the program PR3 (FIG. 5B) from step 300, and advances the process to step 301.

In step 301, the CPU sets the index n for specifying (selecting) the flag FXn to be processed to “1”. The CPU then proceeds to step 302.

In step 302, the CPU determines whether or not the flag FXn is “1”. When the CPU determines that the flag FXn is “1” (302: Yes), the process proceeds to step 303. On the other hand, when the CPU determine that the flag FXn is not “1” (302: No), the process proceeds to step 307, which will be described later.

In step 303, the CPU determines whether the condition Xn1 is unsatisfied. When the CPU determines that the condition Xn1 is unsatisfied (303: Yes), the process proceeds to step 304. On the other hand, when the CPU determines that the condition Xn1 is not unsatisfied (303: No), the process proceeds to step 306, which will be described later.

In step 304, the CPU determines whether or not a particular flag FXn is selected as a process target. That is, the CPU determines whether or not the index n corresponds to any of the particular values [a,b,c, . . . ]. When the CPU determines that a particular flag FXn is selected as a processing target (304: Yes), the processing proceeds to step 305. On the other hand, when the CPU determines that a particular flag FXn is not selected as the processing target (304: No), the processing proceeds to step 306.

In step 305, the CPU determines whether the condition Xn2 is satisfied. When the CPU determines that the condition Xn2 is satisfied (305: Yes), the process proceeds to step 307. That is, the flag FXn is not changed. That is, the CPU maintains the hands-off prohibited status. The state in which the hands-off is prohibited includes a state in which the driver is set to the hands-on mode with a lower driver assistance level than the hands-off mode. On the other hand, when the CPU determines that the condition Xn2 is not satisfied (305: No), the CPU proceeds to step 306.

The CPU sets the flag FXn to “O” in step 306. The CPU then proceeds to step 307.

In step 307, the CPU determines whether the index n is less than the maximal max. When the CPU determines that the index n is less than the maximum-value max (307: Yes), the process proceeds to step 308. On the other hand, when the CPU determine that the index n is not less than the maximal value max (307: No), the process returns to step 301.

The CPU increments the index n at step 308. The CPU then returns to step 302.

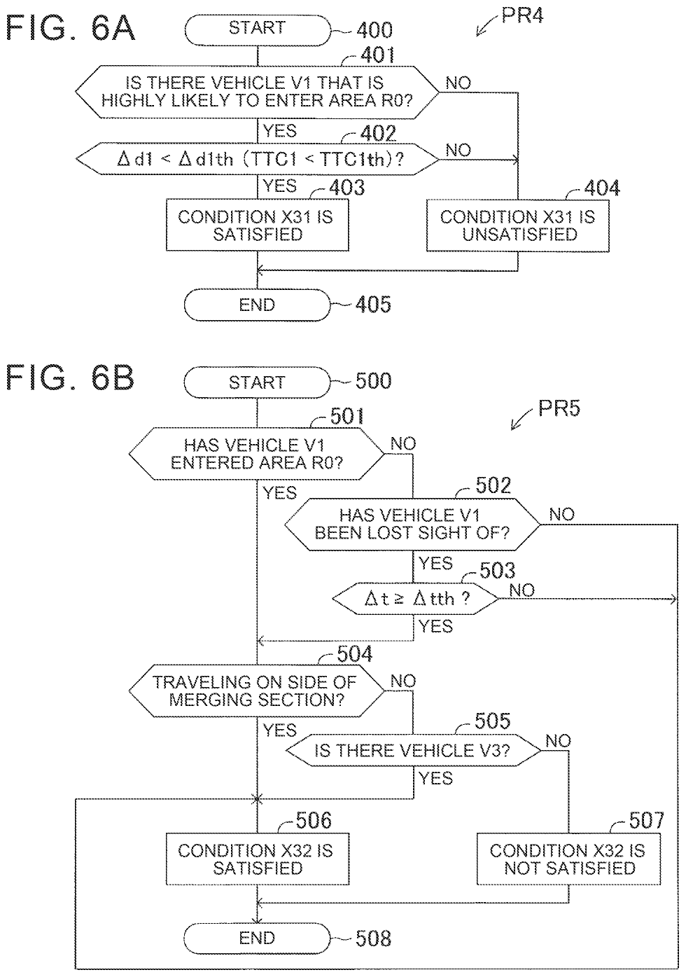

Next, a specific embodiment of a process of determining whether the conditions Xn1, Xn2 are satisfied will be described. When the brake pedal is not depressed, the CPU executes a program PR4 (FIG. 6A) to determine whether the condition X31 is satisfied. The CPU also executes a program PR5 (FIG. 6B) to determine whether the condition X32 is satisfied.

### Program PR4

The CPU starts executing a program PR4 from step 400, and advances the process to step 401.

In step 401, the CPU determines whether there is a vehicle V1 that is likely to enter the area R0. When it is determined that the vehicle V1 is present (401: Yes), the CPU starts the following distance adjustment process and advances the process to step 402. On the other hand, when it is determined that the vehicle V1 is not present (401: No), the CPU advances the process to step 404, which will be described later.

In step 402, the CPU determines whether or not the distance Δd1 (predicted time TTC1) is less than the threshold Δd1th (threshold TTC1th). When the CPU determines that the distance Δd1 (predicted time TTC1) is less than the threshold Δd1th (threshold TTC1th) (402; Yes), the process proceeds to step 403. On the other hand, when the CPU determines that the distance Δd1 (predicted time TTC1) is not less than the threshold Δd1th (threshold TTC1th) (402; No), the process proceeds to step 404.

In step 403, the CPU determines that the condition X31 is satisfied. The CPU then starts measuring the elapsed time Δt. The CPU then finishes executing the program PR4 in step 405.

In addition, the CPU determines in step 404 that the condition X31 is unsatisfied. Next, the CPU advances the process to step 405, and in step 405, the CPU finishes executing the program PR4.

### Program PR5

The CPU starts executing a program PR5 (FIG. 6B) from step 500, and advances the process to step 501.

In step 501, the CPU determines whether the vehicle V1 has entered the area R0. That is, the CPU determines whether the vehicle V1 has detected that the interruption has been completed. When the CPU determines that the vehicle V1 has entered the area R0 (501: Yes), the process proceeds to step 504, which will be described later. On the other hand, when the CPU determines that the vehicle V1 has not entered the area R0 (501: No), the process proceeds to step 502. The case where the CPU determines that the vehicle V1 has not entered the area R0 includes the case where the vehicle V1 is entering the area R0 and the case where the vehicle V1 has been lost sight of.

In step 502, the CPU determines whether the vehicle V1 has been lost sight of (can no longer be perceived). The vehicle V1 is a vehicle related to a factor in which the flag FX3 is set to “1”. When the CPU determines that the vehicle V1 has been lost sight of (502: Yes), the process proceeds to step 503. On the other hand, when the CPU determines that the vehicle V1 has not been lost sight of (502: No), the process proceeds to step 506.

In step 503, the CPU determines whether the elapsed time Δt is equal to or greater than the threshold Δtth. When the CPU determines that the elapsed time Δt is equal to or greater than the threshold Δtth (503: Yes), the process proceeds to step 504 described later. On the other hand, when the CPU determines that the elapsed time Δt is not equal to or greater than the threshold Δtth (503: No), the process proceeds to step 506.

In step 504, the CPU determines whether or not the host vehicle is traveling in the merging section M. When the CPU determines that the host vehicle is traveling in the merging section M (504: Yes), the process proceeds to step 506. On the other hand, when the CPU determines that the host vehicle is not traveling in the merging section M (504: No), the process proceeds to step 505.

In step 505, the CPU determines whether there is a vehicle V3 that is highly likely to enter the area R0. When the CPU determines that V3 of vehicles is present (505: Yes), the process proceeds to step 506. On the other hand, if it is not determined that V3 of vehicles is present (505: No), the CPU proceeds to step 507.

In step 506, the CPU determines that the condition X32 is satisfied. In addition, the CPU determines in step 507 that the condition X32 is unsatisfied. Then, in step 508, the CPU finishes executing the program PR5.

### EFFECTS

According to the driver assistance device 1, after the operation mode MD (driver assistance level) is changed from the hands-off mode (first level) to the hands-on mode (second level), the operation mode MD is maintained in the hands-on mode under a situation where the condition Xn1 (first condition) is highly likely to be satisfied (under a situation where the condition Xn2 is satisfied). Therefore, the driver assistance level is suppressed from being changed more frequently than in the above conventional device.

What is claimed is:

1. A driver assistance device that assists in a driving maneuver of a host vehicle, the driver assistance device comprising:
an in-vehicle sensor configured to acquire target information about a target that is present around the host vehicle; and
a processor configured to perform a driver assistance process of determining a driver assistance level based on the target information and controlling the host vehicle in such a manner that assistance of the driver assistance level is provided to a driver, the driver assistance level being a degree of assistance in the driving maneuver, wherein the processor is configured to
when a first condition is satisfied during the driver assistance process of a predetermined first level, start performing the driver assistance process of a second level instead of the driver assistance process of the first level, the first condition being a condition defined in advance as a condition for lowering the driver assistance level, and the second level being lower than the first level, and
maintain the driver assistance level at the second level during a period in which a second condition is satisfied, the second condition being a condition defined in advance as a condition for determining that a situation is that the first condition is highly likely to be satisfied.

2. The driver assistance device according to claim 1, wherein the processor is configured to
when determination is made that an other vehicle traveling in a second travel lane adjacent to a first travel lane in which the host vehicle is traveling is highly likely to enter the first travel lane, perform a following distance adjustment process of controlling either or both of a drive device of the host vehicle and a braking device of the host vehicle so as to allow the other vehicle to enter an area immediately in front of the host vehicle, and
determine that the first condition is satisfied when a distance between the host vehicle and the other vehicle or a predicted time until contact between the host vehicle and the other vehicle becomes less than a threshold in a situation where the processor is performing the following distance adjustment process.

3. The driver assistance device according to claim 2, wherein the processor is configured to determine that the second condition is satisfied when the host vehicle is traveling in a merging section of a travel lane.

4. The driver assistance device according to claim 2, wherein the processor is configured to determine that the second condition is satisfied in a situation that a still other vehicle different from the other vehicle is highly likely to enter the area.

5. The driver assistance device according to claim 2, wherein the processor is configured to
measure an elapsed time since a first time point at which determination was made that the first condition was satisfied, and
when the other vehicle becomes no longer detectable after the first time point, determine that the second condition is satisfied in a situation where the elapsed time is less than a threshold.
